(19) United States
(12) Patent Application Publication
(10) Pub. No.: US 2012/0104959 A1
(43) Pub. Date: May 3, 2012

(54) IGNITION SYSTEM AND IGNITION METHOD

(75) Inventors: Hiroyuki Kameda, Aichi-ken (JP); Daisuke Nakano, Kiyosu-shi (JP); Naofumi Yamamura, Nagoya-shi (JP); Daisuke Kasahara, Toyoake-shi (JP); Masahiro Nishida, Nagoya-shi (JP)

(73) Assignee: NGK SPARK PLUG CO., LTD.

(21) Appl. No.: 13/280,516

(22) Filed: Oct. 25, 2011

(30) Foreign Application Priority Data
Nov. 1, 2010 (JP) JP 2010-245120

(51) Int. Cl. F02P 3/00

(52) U.S. Cl. 315/209 T

(57) ABSTRACT

An ignition system including a plasma jet spark plug, a discharge power source, and an energy input portion. The spark plug includes a center electrode inserted and installed in the axis hole of an insulator, a ground electrode forming a clearance with the center electrode in between, and a cavity defined by an inner peripheral surface of the axis hole and a top end surface of the center electrode. A plasma is generated in the cavity as the discharge power source generates a spark discharge by applying a voltage to the clearance and the energy input portion inputs electric power into the clearance. The energy input portion inputs electric power into the clearance more than once in a single spark discharge.

### FIELD OF THE INVENTION

The present invention relates to an ignition system and an ignition method of a plasma jet spark plug that ignites an air-fuel mixture by generating a plasma.

### BACKGROUND OF THE INVENTION

A combustion device, such as an internal combustion engine, employs a spark plug that ignites an air-fuel mixture by a spark discharge. In order to fulfill a demand of a higher output and lower fuel consumption for the combustion device, a plasma jet spark plug is now proposed as a spark plug capable of spreading combustion quickly and igniting a lean air-fuel mixture having a higher lean limit in a more reliable manner.

A plasma jet spark plug generally includes a tube-like insulator having an axis hole, a center electrode inserted into the axis hole and installed therein with a top end surface thereof fit below a top end surface of the insulator, a metal shell disposed along an outer periphery of the insulator, and an annular ground electrode sealed to a top end of the metal shell. The plasma jet spark plug also has a space (cavity) defined by the top end surface of the center electrode and an inner peripheral surface of the axis hole and the cavity communicates with an outside via a through hole made in the ground electrode.

In the plasma jet spark plug as above, an air-fuel mixture is ignited as follows. First, a voltage is applied to a clearance formed between the center electrode and the ground electrode to generate a spark discharge in the clearance for a dielectric breakdown to take place. In this circumstance, a discharge state is caused to transition by inputting electric power into the clearance to generate a plasma inside the cavity. An air-fuel mixture is ignited as the plasma thus generated is ejected from an opening of the cavity.

In order to enhance ignitability further, there is a method of providing a throttle to the cavity by forming the inner peripheral surface of the cavity into a step shape as is described, for example, in JP-A-2007-287666. Also, there is proposed a technique of enhancing ignitability by making an axial length of the cavity relatively large while setting a capacity of the cavity to or below a predetermined value as is described, for example, in JP-A-2006-294257.

According to the technique described in JP-A-2007-287666, however, because the inner peripheral surface of the cavity is of a curved (bent) shape, grinding (so-called channeling) of the insulator readily occurs at a region of the curved (bent) shape. In a case where an axial length of the cavity is made relatively large while setting a capacity of the cavity to or below a predetermined value as with the technique described in JP-A-2006-294257, an inside diameter of the cavity becomes smaller as a result and hence an outside diameter at the top end of the center electrode is reduced. Accordingly, heat conduction of the center electrode becomes extremely poor and the center electrode may possibly be worn out rapidly. In other words, in a case where ignitability is enhanced by adjusting the shape of the cavity as with the techniques above, adverse influences may possibly arise in terms of a channeling or wear of the center electrode.

### SUMMARY OF THE INVENTION

The invention was devised in view of the foregoing and has an object to provide an ignition system and an ignition method of a plasma jet spark plug, each of which can enhance ignitability by changing a method of inputting electric power without adverse influences arising in terms of a channeling or wear of the center electrode.

Hereinafter, configurations suitable to achieve the object above will be described one by one, followed by a description of the action and efficiency unique to a configuration when the need arises.

### Configuration 1

An ignition system of this configuration is provided with: a plasma jet spark plug that includes an insulator having an axis hole extending in a direction of an axis line, a center electrode inserted into the axis hole and installed therein in such a manner that a top end surface is situated closer to a rear end than a top end of the insulator in the direction of the axis line, a ground electrode disposed so as to be situated closer to the top end than the top end of the insulator in the direction of the axis line and forming a clearance with the center electrode in between, and a cavity defined by an inner peripheral surface of the axis hole and the top end surface of the center electrode; a discharge power source that applies a voltage to the clearance; and an energy input portion that inputs electric power into the clearance. The ignition system is capable of generating a plasma in the cavity by generating a spark discharge in the clearance by applying a voltage to the clearance from the discharge power source and by inputting electric power into the clearance. The energy input portion is formed to be capable of inputting electric power into the clearance more than once in a single spark discharge. Start timing of second and subsequent inputs of the electric power in the single spark discharge is set after end timing of an immediately preceding input of the electric power and within 50 μs from the end timing of the immediately preceding input.

The term, “the end timing of an input”, referred to herein means a time when a current value of electric power inputted drops to or below 5% of a peak value when the electric power is inputted. The end timing of an input is defined as above in consideration of the fact that a current of a spark discharge (inductive spark discharge current) is still flowing (a current value does not drop to 0) each time the input of electric power to generate a plasma ends. Also, the limit is set to “5% or below” because a current value of a spark discharge is generally not greater than 5% of a current peak value of the electric power inputted to generate a plasma.

According to Configuration 1, electric power is inputted more than once in a single spark discharge and the start timing of the second and subsequent inputs of electric power is set after the end timing of the immediately preceding input of electric power. Accordingly, a plasma generated by the immediately preceding input of electric power is ejected from the cavity on one hand, and on the other hand, electric power is inputted for the second and subsequent times while sufficient fresh air used to generate a plasma has flown into the cavity. It thus becomes possible to generate a sufficiently large plasma at the second and subsequent inputs of electric power.

Moreover, according to Configuration 1, the start timing of the second and subsequent inputs of electric power is set within 50 μs from the end timing of the immediately preceding input of electric power. Hence, it is configured in such a manner that a following plasma is generated at timing before a plasma generated by the immediately preceding input of electric power disappears. It thus becomes possible to let a plasma generated by the immediately preceding input of electric power be forced out by a large plasma generated by the following input of electric power to burst out from the cavity. As a result, ignitability can be enhanced markedly without particularly adjusting a shape of the cavity (without adverse influences arising in terms of a channeling or wear of the center electrode).

Also, according to Configuration 1, it becomes possible to enhance ignitability sufficiently even when a current peak value of electric power per input is made relatively small. Accordingly, a thermal load on the center electrode accompanying an input of electric power can be reduced and wear of the center electrode can be therefore suppressed. As a result, a rise of a spark discharge voltage associated with wear of the center electrode can be suppressed and a channeling can be therefore suppressed. Also, by suppressing a rise of a spark discharge voltage, it becomes possible to extend a period in which a spark discharge or the like is enabled. Hence, together with the suppression of a channeling, it becomes possible to maintain excellent ignitability over a long period.

### Configuration 2

An ignition system of this configuration is the ignition system of Configuration 1 above configured in such a manner that let D (mm) be an inside diameter of the cavity and E (mJ) be energy to be supplied to the clearance from the energy input portion per input of electric power, then inequalities below are satisfied:

when D≦0.8,

E≧19 (mJ/mm²)×π×(0.4 mm)², and

when D>0.8,

E≧19 (mJ/mm²)×π×(D/2)².

In a case where the inside diameter of the cavity varies along the direction of the axis line, such as a case where an inner peripheral surface of the axis hole forming the cavity inclines with respect to the axis line, the term, “the inside diameter of the cavity”, means an average inside diameter of the cavity along the direction of the axis line (the same applies to a description below).

The inventors checked a relation of an ejection amount of a plasma and a state of the plasma in the cavity and found that the cavity was filled with a plasma when an ejection amount of a plasma reached 0.4 mm or more.

In view of the foregoing, according to Configuration 2, energy to be supplied to the clearance per input of electric power is set so as to conform to the inequalities above according to the inside diameter D of the cavity, so that a plasma is generated and ejected by at least 0.4 mm per input of electric power. In other words, according to Configuration 2, it becomes possible to fill the cavity with a plasma in a reliable manner when electric power is inputted. It thus becomes possible to let a plasma generated immediately before be forced out by a plasma generated next in a more reliable manner. Ignitability can be therefore enhanced in a more reliable manner.

### Configuration 3

An ignition system of this configuration is the ignition system of Configuration 1 or 2 above configured in such a manner that the start timing of a last input of the electric power in the single spark discharge is set within 500 μs from a start of the spark discharge.

According to Configuration 3, the last input of electric power in a single spark discharge is made while the spark discharge exists and a resistance of the clearance is sufficiently small. It thus becomes possible to generate a plasma in a more reliable manner even by the last input of electric power in a single spark discharge. Ignitability can be therefore enhanced efficiently.

### Configuration 4

An ignition system of this configuration is the ignition system of any one of Configurations 1 through 3 above configured in such a manner that let D (mm) be an inside diameter of the cavity, then an inequality below is satisfied:

0.5≦D≦2.0.

According to Configuration 4, because the inside diameter D of the cavity is set to 0.5 mm or greater, it becomes possible to secure a sufficiently large volume at the top end of the center electrode that is inserted into the axis hole. As a result, thermal conductivity of the center electrode can be increased and wear resistance of the center electrode can be enhanced further.

Also, because the inside diameter D of the cavity is set to 2.0 mm or less, it becomes possible to make supply energy necessary to fill the cavity with a plasma sufficiently small. It thus becomes possible to suppress effectively wear of the center electrode associated with an input of electric power.

### Configuration 5

An ignition system of this configuration is the ignition system of any one of Configurations 1 through 4 above configured in such a manner that at least one of a straight portion having a constant inside diameter and a diameter expanding portion having an inside diameter expanding toward the top end in the direction of the axis line is provided to the axis hole in a range of at least 0.5 mm from the top end of the axis hole toward the rear end in the direction of the axis line.

According to Configuration 5, the sufficiently long straight portion of 0.5 mm or longer is provided to the cavity on the top end side and an opening of the cavity is made without becoming narrower. Accordingly, fresh air flows more smoothly into the cavity and a further larger plasma can be generated at the second and subsequent inputs of electric power. Also, by providing the straight portion at the top end of the cavity, it becomes possible to suppress scattering of a plasma when ejected from the cavity. Hence, as these efficiencies are multiplied, ignitability can be enhanced still further.

Also, because fresh air flows more smoothly into the cavity, a thermal load on the center electrode can be reduced further. It thus becomes possible to enhance wear resistance of the center electrode still further.

### Configuration 6

An ignition system of this configuration is the ignition system of Configuration 5 above configured in such a manner that the diameter expanding portion is provided to the axis hole in the region of at least 0.5 mm from the top end of the axis hole toward the rear end in the direction of the axis line, and that let α (°) be an acute angle complementary to an obtuse angle yielded between a visible outline of the diameter expanding portion and the axis line in a cross section including the axis line, then an inequality below is satisfied:

0<α≦15.

According to Configuration 6, because the diameter expanding portion is provided to the axis hole (cavity) on the top end side, fresh air flows more smoothly into the cavity. As a result, ignitability and wear resistance of the center electrode can be further enhanced.

When an increase ratio of the inside diameter of the diameter expanding portion toward the top end in the direction of the axis line (namely, the angle α) becomes excessively large, a plasma scatters when ejected and an ejection amount of a plasma may possibly decrease. However, according to Configuration 6, the angle α is set sufficiently small to 15° or less. It thus becomes possible to suppress scattering of a plasma in a more reliable manner and hence to let the ignitability enhancing efficiency described above be exerted in a more reliable manner.

### Configuration 7

An ignition system of this configuration is the ignition system of any one of Configurations 1 through 6 above configured in such a manner that, of the center electrode, a region of 0.3 mm from a top end thereof toward the rear end in the direction of the axis line is made of one of metals including tungsten (W), iridium (Ir), platinum (Pt), and nickel (Ni), and alloy having at least one of the metals as a chief ingredient.

The term, “chief ingredient”, referred to herein means a component having a highest mass ratio among the materials (the same applies to a description below).

According to Configuration 7, the top end of the center electrode is made of metal, such as W and Ir, or alloy having at least one of these metals as the chief ingredient. It thus becomes possible to further enhance wear resistance of the center electrode caused by a spark discharge.

### Configuration 8

An ignition system of this configuration is the ignition system of any one of Configurations 1 through 7 above configured in such a manner that the ground electrode is made of one of metals including W, Ir, Pt, and Ni, and alloy having at least one of the metals as a chief ingredient.

According to Configuration 8, the ground electrode is made of metal, such as W and Ir, or alloy having at least one of these metals as the chief ingredient. It thus becomes possible to further enhance wear resistance of the ground electrode caused by a spark discharge. A rise of a spark discharge voltage associated with wear of the ground electrode can be therefore suppressed. As a result, it becomes possible to extend a period in which a spark discharge is enabled and excellent ignitability achieved by the respective configurations described above can be maintained over a further longer period.

### Configuration 9

An ignition method of this configuration is an ignition method of an ignition system provided with: a plasma jet spark plug that includes an insulator having an axis hole extending in a direction of an axis line, a center electrode inserted into the axis hole and installed therein in such a manner that a top end surface is situated closer to a rear end than a top end of the insulator in the direction of the axis line, a ground electrode disposed so as to be situated closer to the top end than the top end of the insulator in the direction of the axis line and forming a clearance with the center electrode in between, and a cavity defined by an inner peripheral surface of the axis hole and the top end surface of the center electrode; a discharge power source that applies a voltage to the clearance; and an energy input portion that inputs electric power into the clearance, for generating a plasma in the cavity by generating a spark discharge in the clearance by applying a voltage to the clearance from the discharge power source and by inputting electric power into the clearance. The ignition method includes: inputting electric power into the clearance more than once in a single spark discharge from the energy input portion; and setting start timing of second and subsequent inputs of the electric power in the single spark discharge after end timing of an immediately preceding input of the electric power and within 50 μs from the end timing of the immediately preceding input.

According to Configuration 9, basically, it becomes possible to achieve the same action and efficiency achieved by Configuration 1 above.

### BRIEF DESCRIPTION OF THE DRAWINGS

FIG. 1 is a block diagram schematically showing the configuration of an ignition system;

FIG. 2 is a partially broken front view showing the configuration of a plasma jet spark plug;

FIG. 3 is a timing chart used to describe input timing of electric power and charge timing of capacitors;

FIG. 4 is a timing chart used to describe input timing of electric power;

FIG. 5 is an expanded partial sectional view showing the configuration of a top end of the plasma jet spark plug;

FIG. 6 is an expanded partial sectional view showing another example of the top end of the plasma jet spark plug;

FIG. 7A is an expanded partial sectional view showing the configuration of a sample A and FIG. 7B is an expanded partial sectional view showing the configuration of a sample B;

FIG. 8 is a graph showing a relation of the number of input times of electric power and a flame area in the sample A and the sample B;

FIG. 9 is a graph showing a relation of an input interval of electric power and the flame area;

FIG. 10 is a graph showing a relation of a sectional area of a cavity and supply energy necessary to obtain an ejection amount of a plasma equal to 0.4 mm or more;

FIG. 11 is a graph showing a relation of an inside diameter of the cavity and supply energy necessary to obtain an ejection amount of a plasma equal to 0.4 mm or more;

FIG. 12 is a graph showing a relation of the inside diameter of the cavity and an endurance time;

FIG. 13A is an expanded partial sectional view showing the configuration of a sample C and FIG. 13B is an expanded partial sectional view showing the configuration of a sample D;

FIG. 14 is an expanded partial sectional view showing the configuration of a sample E;

FIG. 15 is a graph showing a relation of a length of a straight portion and the flame area;

FIG. 16 is a graph showing a relation of an angle α and the flame area; and

FIG. 17 is a block diagram schematically showing the configuration of an ignition system according to another embodiment.

### DETAILED DESCRIPTION OF THE INVENTION

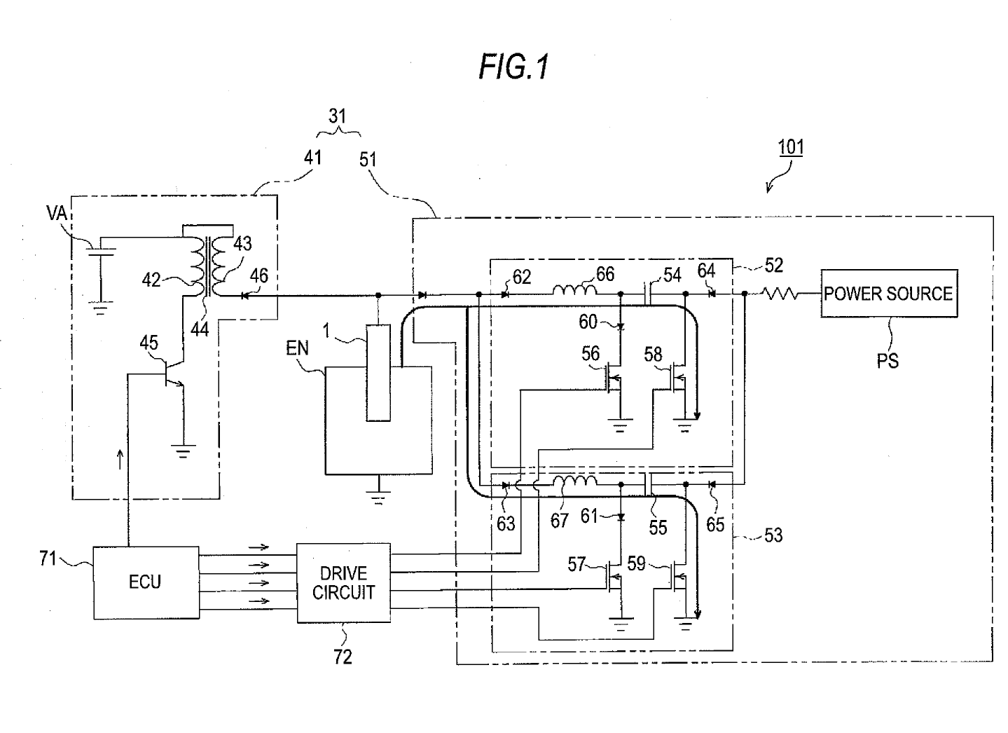

Hereinafter, one embodiment will be described with reference to the drawings. FIG. 1 is a block diagram schematically showing the configuration of an ignition system 101 including a plasma jet spark plug (hereinafter, referred to as the spark plug) 1 and an ignition device 31 having a discharge power source 41 and an energy input portion 51. FIG. 1 shows only one spark plug 1. It should be appreciated, however, that an internal combustion engine EN is provided with a plurality of cylinders and one spark plug 1 is provided correspondingly to each cylinder and that the discharge power source 41 and the energy input portion 51 are provided to each spark plug 1.

Prior to a description of the ignition system 101, the schematic configuration of the spark plug 1 will be described.

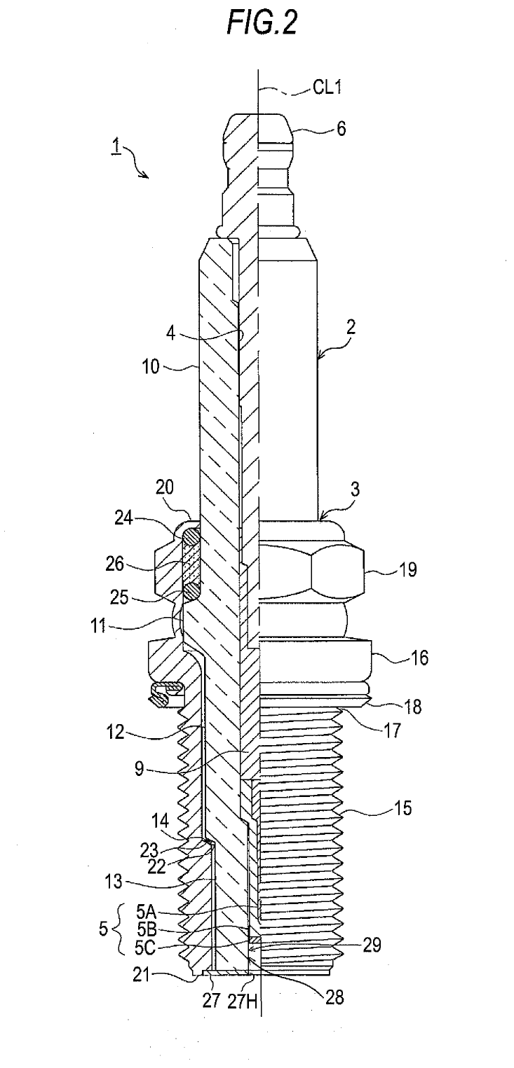

FIG. 2 is a partially broken front view of the spark plug 1. A description will be given with reference to FIG. 2 on the assumption that a direction of an axis line CL1 of the spark plug 1 is a top-bottom direction and a lower side and an upper side are a top end side and a rear end side of the spark plug 1, respectively.

The spark plug 1 is formed of a tube-like insulating ceramics 2 as an insulator and a tube-like metal shell 3 holding the insulating ceramics 2.

The insulating ceramics 2 is formed by firing alumina or the like as is known and includes, on an outward form portion, a rear end shank portion 10 provided on the rear end side, a large diameter portion 11 provided closer to the top end than the rear end shank portion 10 so as to protrude radially outward, a middle shank portion 12 provided closer to the top end and having a smaller diameter than the large diameter portion 11, and an insulator nose portion 13 provided closer to the top end and having a smaller diameter than the middle shank portion 12. Of the insulating ceramics 2, the large diameter portion 11, the middle shank portion 12, and the insulator nose portion 13 are housed inside the metal shell 3. A tapered step portion 14 is formed in a connection portion of the middle shank portion 12 and the insulator nose portion 13 and the insulating ceramics 2 is locked to the metal shell 3 at the step portion 14.

Moreover, the insulating ceramics 2 is provided with an axis hole 4 that penetrates through the insulating ceramics 2 along the axis line CL1. A center electrode 5 is inserted into the axis hole 4 on the top end side and fixed therein. The center electrode 5 includes an inner layer 5A made of copper, copper alloy, or the like having excellent thermal conductivity and an outer layer 5B made of Ni alloy having nickel (Ni) as the chief ingredient (for example, Inconel (registered trademark) 600 or 601). Moreover, the center electrode 5 is shaped like a rod (column) as a whole and a top end thereof is disposed closer to the rear end than the top end surface of the insulating ceramics 2. In addition, an electrode chip 5C made of tungsten (W), iridium (Ir), platinum (Pt), nickel (Ni) or alloy having at least one of these metals as the chief ingredient is provided to the center electrode 5 in a region at least 0.3 mm from the top end toward the rear end in the direction of the axis line CL1.

A terminal electrode 6 is inserted into the axis hole 4 on the rear end side and fixed therein while protruding from the rear end of the insulating ceramics 2.

Moreover, a column-like glass seal layer 9 is disposed between the center electrode 5 and the terminal electrode 6. The glass seal layer 9 electrically connects the center electrode 5 and the terminal electrode 6 and fixes the center electrode 5 and the terminal electrode 6 to the insulating ceramics 2.

In addition, the metal shell 3 is made of metal, such as low-carbon steel, in a tube shape and provided with a screw portion (male screw portion) 15 on the outer peripheral surface to install the spark plug 1 in an attachment hole of a combustion device (for example, an internal combustion engine or a fuel cell reformer). The metal shell 3 is also provided with a seat portion 16 on the outer peripheral surface on the rear end side of the screw portion 15. A ring-like gasket 18 is fit to a screw neck 17 at the rear end of the screw portion 15. Moreover, on the rear end side, the metal shell 3 is provided with a tool engagement portion 19 having a hexagonal cross section with which to engage a tool, such as a wrench, when the metal shell 3 is installed to the combustion device and a crimping portion 20 at the rear end to hold the insulating ceramics 2. In addition, an annular engagement portion 21 is provided to the metal shell 3 along the outer periphery at the top end so as to protrude toward the top end in the direction of the axis line CL1. A ground electrode 27 described below is sealed to the engagement portion 21.

The metal shell 3 is provided with a tapered step portion 22 on the inner peripheral surface to lock the insulating ceramics 2. The insulating ceramics 2 is inserted into the metal shell 3 from the rear end side toward the top end and fixed to the metal shell 3 by crimping an opening of the metal shell 3 on the rear end side radially inward, namely, by forming the crimping portion 20 while the step portion 14 thereof is locked to the step portion 22 of the metal shell 3. It should be noted that an annular sheet packing 23 is interposed between the step portion 14 of the insulating ceramics 2 and the step portion 22 of the metal shell 3. Owing to this configuration, the interior of a combustion chamber is maintained airtight so that a fuel gas coming into a clearance between the insulation nose portion 13 of the insulating ceramics 2 and the inner peripheral surface of the metal shell 3 is prevented from leaking to the outside.

Moreover, in order to make the sealing by crimping more complete, annular ring members 24 and 25 are interposed between the metal shell 3 and the insulating ceramics 2 on the rear end side of the metal shell 3 and a space between the ring members 24 and 25 is filled with powder of talc 26. Namely, the metal shell 3 holds the insulating ceramics 2 via the sheet packing 23, the ring members 24 and 25, and the talc 26.

Also, the column-like ground electrode 27 is sealed to the top end of the metal shell 3 to be situated closer to the top end than the top end of the insulating ceramics 2 in the direction of the axial line CL1. The ground electrode 27 is sealed to the metal shell 3 as the outer peripheral portion thereof is welded to the engagement portion 21 while being engaged with the engagement portion 21 of the metal shell 3. In this embodiment, the ground electrode 27 is made of W, Ir, Pt, Ni, or alloy having at least one of these metals as the chief ingredient.

In addition, the ground electrode 27 has a through hole 27H that penetrates through the ground electrode 27 at the center in a plate thickness direction. A cavity 28, which is a column-like space defined by the inner peripheral surface of the axis hole 4 and the top end surface of the center electrode 5 and opening toward the top end, communicates with the outside via the through hole 27H.

In the spark plug 1 as described above, a spark discharge is generated by applying a high voltage to a clearance 29 formed between the center electrode 5 and the ground electrode 27. A discharge state is then caused to transition by inputting electric power into the clearance 29 to generate a plasma in the cavity 28, and the plasma is ejected from the through hole 27H. Accordingly, the configuration of the ignition device 31 that supplies a high voltage and electric power to the clearance 29 in the spark plug 1 will be described next.

As is shown in FIG. 1, the ignition device 31 includes the discharge power source 41, the energy input portion 51, and an electronic control unit (ECU) 71 of an automobile.

The discharge power source 41 generates a spark discharge in the clearance 29 by applying a high voltage to the spark plug 1. The discharge power source 41 includes a primary winding 42, a secondary winding 43, a core 44, and an ignitor 45.

The primary winding 42 is wound about the core 44 and connected to an electric power supply battery VA at one end and to the ignitor 45 at the other end. The secondary winding 43 is wound about the core 44 and connected between the primary winding 42 and the battery VA at one end and to the terminal electrode 6 of the spark plug 1 at the other end via a backflow preventing diode 46.

In addition, the ignitor 45 is formed of a predetermined transistor and switches a supply and a supply stop of electric power to the primary winding 42 from the battery VA according to an electricity-applying signal inputted therein from the ECU 71. In a case where a high voltage is applied to the spark plug 1, a current flows from the battery VA to the primary winding 42 to generate a magnetic field on the periphery of the core 44. Then, the current from the battery VA to the primary winding 42 is stopped by switching an electricity-applying signal from the ECU 71 from ON to OFF. The magnetic field of the core 44 changes when the current stops and not only a primary voltage is generated in the primary winding 42 by a self-dielectric effect but also a high voltage (several to several tens kV) is generated in the secondary winding 43. A spark discharge is generated in the clearance 29 by applying this high voltage to the spark plug 1 (terminal electrode 6).

The energy input portion 51 includes a first energy input portion 52 and a second energy input portion 53 connected in parallel and a power source PS that generates a voltage of a positive polarity.

The first and second energy input portions 52 and 53 input plasma-generating electric power into the spark plug 1. The first energy input portion 52 includes a first capacitor 54, a first charge switch 56, and a first energy input switch 58. The second energy input portion 53 includes a second capacitor 55, a second charge switch 57, and a second energy input switch 59.

The capacitors 54 and 55 each are configured to be charged by the power source PS when connected to the power source PS at one end and connected to the spark plug 1 at the other end. The charge switch 56 (57) switches an application of electricity and an application stop of electricity to the capacitor 54 (55) from the power source PS and is formed of an MOSFET in this embodiment. The charge switch 56 (57) is connected between the capacitor 54 (55) and the spark plug 1 at one end via a backflow preventing diode 60 (61) and grounded at the other end. Also, a signal is inputted to a gate of the charge switch 56 (57) from the ECU 71 via a drive circuit 72. The charge switch 56 (57) switches ON when an ON signal is sent to the charge switch 56 (57) from the ECU 71. The charge switch 56 (57) switches OFF when an OFF signal is sent thereto from the ECU 71. In brief, ON and OFF switching of the both charge switches 56 and 57 is controlled by the ECU 71.

The energy input switch 58 (59) switches an input and an input stop of electric power to the spark plug 1 from the capacitor 54 (55) and is formed of an MOSFET in this embodiment. The energy input switch 58 (59) is connected between the capacitor 54 (55) and the power source PS at one end and grounded at the other end. Moreover, a signal is inputted to a gate of the energy input switch 58 (59) from the ECU 71 via the drive circuit 72. The energy input switch 58 (59) switches ON when an ON signal is sent to the energy input switch 58 (59) from the ECU 71. The energy input switch 58 (59) switches OFF when an OFF signal is sent thereto from the ECU 71. In brief, ON and OFF switching of the both energy input switches 58 and 59 is controlled by the ECU 71 as with the charge switches 56 and 57.

When the capacitor 54 (55) is charged by the power source PS, the charge switch 56 (57) is switched ON whereas the energy input switch 58 (59) is switched OFF by the ECU 71. When electric power stored in the capacitor 54 (55) is inputted into the spark plug 1, the charge switch 56 (57) is switched OFF whereas the energy input switch 58 (59) is switched ON by the ECU 71.

Moreover, the energy input portion 52 (53) includes diodes 62 and 64 (63 and 65) and is therefore configured so as to prevent an occurrence of a current backflow when the capacitor 54 (55) is charged or electric power is inputted into the spark plug 1. The energy input portion 52 (53) is provided with a winding 66 (67) and the windings 66 and 67 prevent electric power from being inputted into the spark plug 1 all at once.

The ECU 71 controls voltage application timing and electric power input timing to the spark plug 1. Also, the ECU 71 is configured to be capable of inputting electric power stored in the capacitors 54 and 55 to the spark plug 1 more than once in a single spark discharge by controlling the charge switches 56 and 57 and the energy input switches 58 and 59.

For example, the capacitors 54 and 55 are charged by switching ON the both charge switches 56 and 57 and switching OFF the both energy input switches 58 and 59. Then, electric power stored in the first capacitor 54 is inputted into the spark plug 1 by switching ON the first energy input switch 58 in synchronization with a spark discharge (timing at which the electricity-applying signal is switched OFF) while the both charge switches 56 and 57 are kept switched OFF. Moreover, electric power is inputted into the spark plug 1 from the second capacitor 55 by switching ON the second energy input switch 59 during the spark discharge and after a completion of the input of electric power into the spark plug 1 from the first capacitor 54. By controlling the respective switches 56 through 59 in this manner, it becomes possible to input electric power more than once in a single spark discharge.

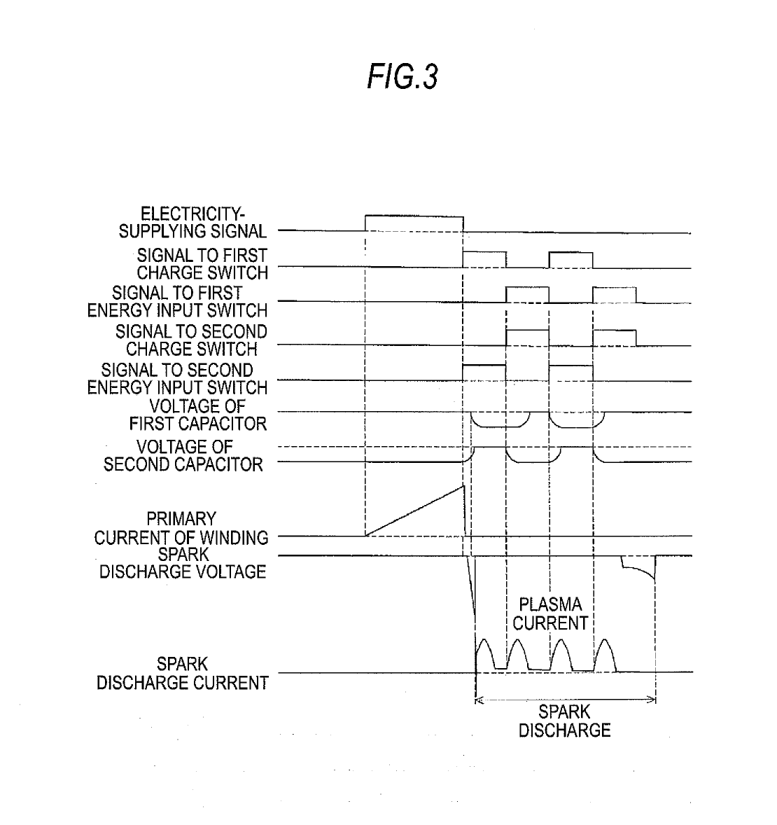

It is also possible to input electric power into the spark plug 1 a larger number of times than the number of the energy input portions 52 and 53 in a single spark discharge by charging the capacitors 54 and 55 during the spark discharge. For example, as is shown in FIG. 3, the first capacitor 54 is charged by switching ON the first charge switch 56 and switching OFF the first energy input switch 58 in the first energy input portion 52. On the other hand, electric power stored in the second capacitor 55 is inputted into the spark plug 1 by switching ON the second energy input switch 59 in synchronization with a spark discharge while keeping the second charge switch 57 switched OFF in the second energy input portion 53. Thereafter, an input of electric power into the spark plug 1 and charging of the capacitors 54 and 55 are carried out alternately in the respective energy input portions 52 and 53 by switching ON and OFF states of the respective switches 56 through 59. It thus becomes possible to input electric power into the spark plug 1 many times in a single spark discharge using the two energy input portions 52 and 53.

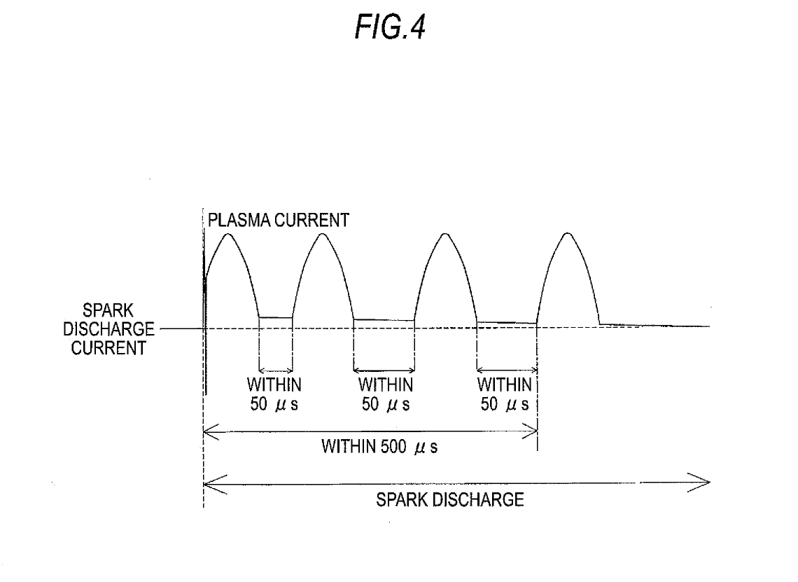

In this embodiment, input timing of electric power is controlled by the ECU 71 as follows. Namely, as is shown in FIG. 4, electric power is inputted into the clearance 29 more than once in a single spark discharge and start timing of the second and subsequent inputs of electric power in a single spark discharge is set after end timing of the immediately preceding input of electric power and within 50 μs from the end timing of this input. On the other hand, the start timing of a last input of electric power in a single spark discharge is set within 500 μs from the start of this spark discharge. The term, “the end timing of an input”, referred to herein means a time when a current value of electric power inputted drops to or below 5% of a peak value when the electric power is inputted.

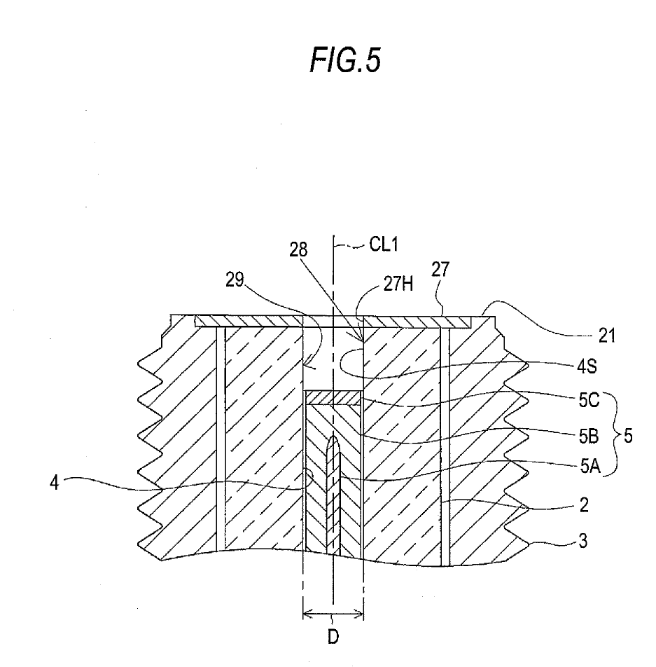

In addition, energy to be supplied to the clearance 29 from the energy input portion 51 at an input of electric power is set as follows in response to a shape of the cavity 28. Namely, let E (mJ) be energy supplied to the clearance 29 from the energy input portion 51 per input of electric power and D (mm) be an inside diameter of the cavity 28 (see FIG. 5), then energy to be supplied per input of electric power is set so as to satisfy:

when D≦0.8,

E≧19 (mJ/mm²)×π×(0.4 mm)², and

when D>0.8,

E≧19 (mJ/mm²)×π×(D/2)².

In this embodiment, the cavity 28 is formed to have the inside diameter D (mm) satisfying, 0.5≦D≦2.0. In order to prevent a spark discharge voltage from increasing exceedingly while maintaining a sufficient insulation property between both electrodes 5 and 27, a length of the cavity 28 along the axis line CL1 is set to a range from 0.5 mm to 2.5 mm both inclusive.

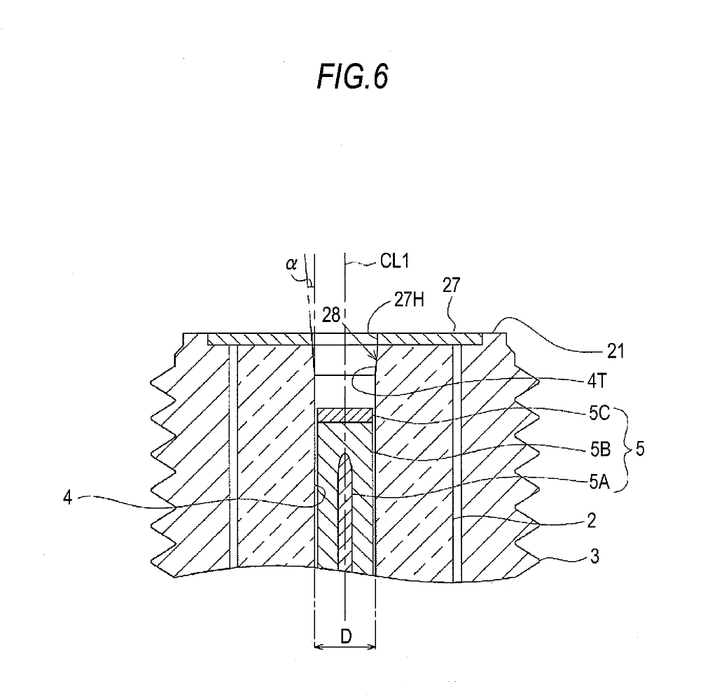

Moreover, a shape of the cavity 28 is set correspondingly to the configuration that energy is inputted therein more than once from the energy input portion 51. Namely, the axis hole 4 is provided with a straight portion 4S having a constant inside diameter in a range of at least 0.5 mm from the top end of the axis hole 4 toward the rear end in the direction of the axis line CL1. Alternatively, as is shown in FIG. 6, instead of the straight portion 4S, a tapered diameter expanding portion 4T having an inside diameter expanding toward the top end in the direction of the axis line CL1 may be provided to the axis hole 4 in a range of at least 0.5 mm from the top end toward the rear end in the direction of the axis line CL1. It should be noted that in a case where the diameter expanding portion 4T is provided, it is preferable to form the diameter expanding portion 4T to satisfy, 0<α≦15, where α (°) is an acute angle complementary to an obtuse angle yielded between a visible outline of the diameter expanding portion 4T and the axis line CL1 in a cross section including the axis line CL1. Also, a diameter shrinking portion having an inside diameter shrinking toward the top end in the direction of the axis line CL1 may be provided to the axis hole 4 in a region closer to the rear end than the straight portion 4S and the diameter expanding portion 4T in the direction of the axis line CL1. In a case where the inside diameter of the cavity 28 varies along the direction of the axis line CL1, such as a case where the diameter expanding portion 4T or the diameter shrinking portion is provided, the term, “the inside diameter D of the cavity 28”, referred to herein means an average of the inside diameters in several portions of the cavity 28 along the direction of the axis line CL1 (for example, a foremost portion and a rearmost portion of the cavity 28).

As has been described, according to this embodiment, electric power is inputted more than once in a single spark discharge and the start timing of the second and subsequent inputs of electric power is set after the end timing of the immediately preceding input of electric power. Accordingly, a plasma generated by the immediately preceding input of electric power is ejected from the cavity 28 on one hand, and on the other hand, electric power is inputted for the second and subsequent times while sufficient fresh air used to generate a plasma has flown into the cavity 28. It thus becomes possible to generate a sufficiently large plasma by the second and subsequent inputs of electric power.

Moreover, in this embodiment, the start timing of the second and subsequent inputs of electric power is set within 50 μs from the end timing of the immediately preceding input of electric power. Hence, it is configured in such a manner that a following plasma is generated at timing before a plasma generated by the immediately preceding input of electric power disappears. It thus becomes possible to let a plasma generated by the immediately preceding input of electric power be forced out by a large plasma generated by the following input of electric power to burst out from the cavity 28. As a result, ignitability can be enhanced markedly.

Also, according to the ignition system 101 of this embodiment, it becomes possible to enhance ignitability sufficiently even when a current peak value of electric power per input is made relatively small. Accordingly, a thermal load on the center electrode 5 accompanying an input of electric power can be reduced. Hence, wear of the center electrode 5 can be suppressed and it becomes possible to suppress a rise of a spark discharge voltage associated with wear of the center electrode 5. As a result, a channeling can be suppressed and a period in which a spark discharge is enabled can be extended. It thus becomes possible to maintain excellent ignitability over a long period.

Moreover, in this embodiment, let D (mm) be an inside diameter of the cavity 28 and E (mJ) be energy to be supplied to the clearance 29 from the energy input portion 51 per input of the electric power, then inequalities below are satisfied:

when D≦0.8,

E≧19 (mJ/mm²)×π×(0.4 mm)², and

when D>0.8,

E≧19 (mJ/mm²)×π×(D/2)².

Accordingly, it becomes possible to fill the cavity 28 with a plasma in a reliable manner when electric power is inputted. It thus becomes possible to let a plasma generated immediately before be forced out by a plasma generated next in a more reliable manner. Ignitability can be therefore enhanced in a more reliable manner.

In addition, the start timing of a last input of the electric power in a single spark discharge is set within 500 μs from a start of the spark discharge. In other words, it is configured in such a manner that the last input of electric power in a single spark discharge is made while the spark discharge exists and a resistance of the clearance 29 is sufficiently small. It thus becomes possible to generate a plasma in a reliable manner even by the last input of electric power in a single spark discharge. Ignitability can be therefore enhanced efficiently.

Also, because the inside diameter D of the cavity 28 is set to a range from 0.5 mm to 2.0 mm both inclusive, not only can thermal conductivity of the center electrode 5 be increased, but also supply energy necessary to fill the cavity 28 with a plasma can be made sufficiently small. As a result, wear resistance of the center electrode 5 can be suppressed still further.

Also, the sufficiently long straight portion 4S of 0.5 mm or longer is provided to the cavity 28 on the top end side and an opening of the cavity 28 is made without becoming narrower. Accordingly, fresh air flows more smoothly into the cavity 28 and a further larger plasma can be generated at an input of electric power. Also, by providing the straight portion 4S at the top end of the cavity 28, it becomes possible to suppress scattering of a plasma when ejected from the cavity 28. Hence, as these efficiencies are multiplied, ignitability can be enhanced still further. Also, because fresh air flows more smoothly into the cavity 28, a thermal load on the center electrode 5 can be reduced further. It thus becomes possible to further enhance wear resistance of the center electrode 5. In a case where the diameter expanding portion 4T having an inside diameter expanding toward the top end along the direction of the axis line CL1 is provided instead of the straight portion 4S, fresh air flows further smoothly into the cavity 28. Further enhanced ignitability can be therefore expected. Also, by setting the angle α of the diameter expanding portion 4T to be larger than 0° and not larger than 15°, it becomes possible to suppress scattering of a plasma when it is ejected.

In addition, the top end of the center electrode 5 and the ground electrode 27 are made of metals, such as W and Ir, or alloy having at least one of these metals as the chief ingredient. It thus becomes possible to enhance wear resistance of the center electrode 5 and the ground electrode 27 caused by a spark discharge. A rise of a spark discharge voltage associated with wear of the center electrode 5 and the ground electrode 27 can be therefore suppressed. As a result, it becomes possible to extend a period in which a spark discharge is enabled and excellent ignitability can be maintained over a further longer period.

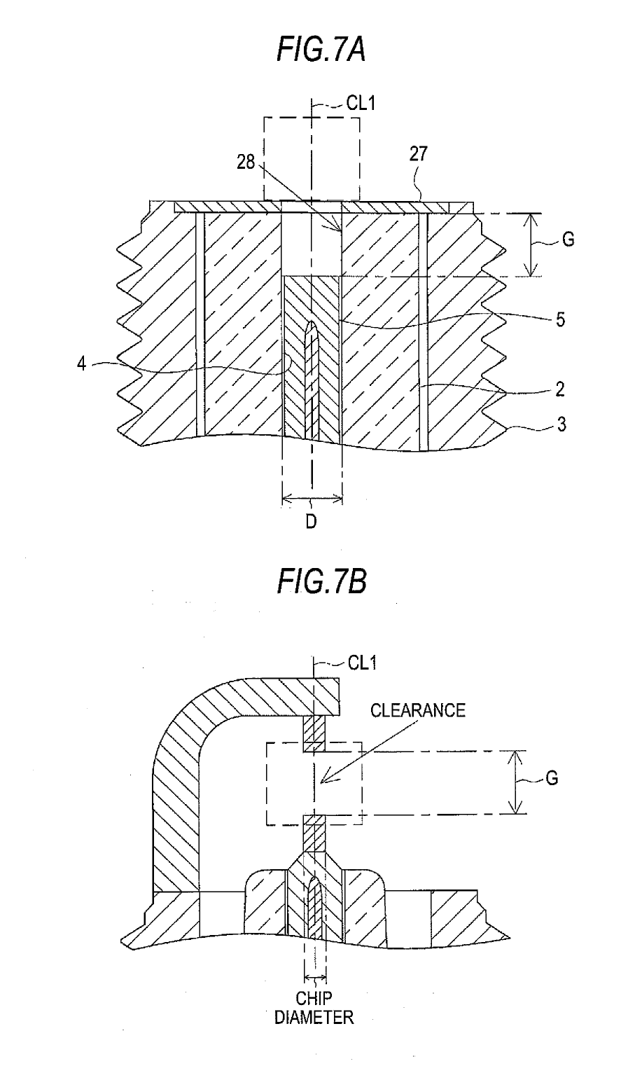

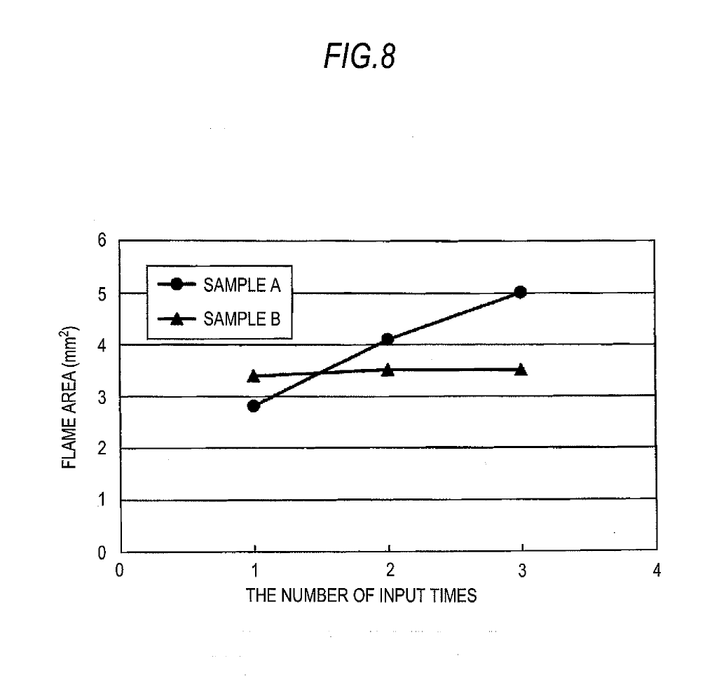

In order to confirm the action and efficiency achieved by the embodiment described above, a sample A (corresponding to the embodiment) of a spark plug having, as is shown in FIG. 7A, a cavity and a clearance formed between a center electrode and a ground electrode and situated inside the cavity was manufactured. Also, a sample B (corresponding to a comparative example) of a spark plug having, as is shown in FIG. 7B, a center electrode protruding from a top end of an insulating ceramics toward a top end in the direction of an axis line and provided with no cavity was manufactured. Then, flame areas when electric power was inputted one, two, and three times in a single spark discharge were measured in both samples. The flame areas were measured as follows. Namely, after the sample was installed in a predetermined chamber, an internal pressure of the chamber was set to 0.4 MPa and an internal atmosphere of the chamber was made a standard gas atmosphere (atmosphere). Then, electric power per input was set so that electric power of 60 mJ was inputted in total (namely, in a case where electric power was to be inputted two times in a single spark discharge, energy to be supplied per input of electric power was set to 30 mJ and in a case where electric power was to be inputted three times in a single spark discharge, energy to be supplied per input of electric power was set to 20 mJ). A schlieren image after 100 μs from a spark discharge in a region (a region enclosed by a broken line in FIG. 7A) on the top end side of a through hole was obtained with the sample A. A schlieren image after 100 μs from a spark discharge in a clearance formed between the center electrode and the ground electrode and in the vicinity thereof (a region enclosed by a broken line in FIG. 7B) was obtained with the sample B. Then, the schlieren images thus obtained were converted to digital forms using a predetermined threshold and an area of a high density portion (namely, a portion where a plasma was generated) was measured as the flame area. Because the interior of the chamber was made a standard gas atmosphere in this test, ignition of an air-fuel mixture or the like by flame (plasma) was not carried out and the measured flame area therefore directly indicates a size of the generated plasma itself. In a case where electric power was inputted two or three times, the start timing of the second and subsequent inputs of electric power was set after the end timing of the immediately preceding input of electric power and within 50 μs from the end timing of this input. Moreover, the inside diameter D of the cavity was set to 1.0 mm and the size G of the clearance was set to 1.0 mm in the sample A. In addition, each of the center electrode and the ground electrode in the sample B was provided with a needle-like chip member having a diameter of φ0.4 mm and a clearance was formed between the both chip members to have a size G of 1.0 mm. FIG. 8 shows a graph showing a relation of the number of input times of electric power in a single spark discharge and the flame area with the both samples. In FIG. 8, the test result of the sample A is indicated by circles and the test result of the sample B is indicated by triangles.

As is shown in FIG. 8, it was found that in a case where electric power was inputted one time, the flame area of the sample B was larger than the flame area of the sample A, whereas in a case where electric power was inputted two or more times, the flame area of the sample A was far larger the flame area of the sample B and excellent ignitability was achieved in the sample A. The reason for this is believed to be that an ejection force of a generated plasma toward the top end in the direction of the axis line increased owing to the presence of the cavity and also a plasma generated immediately before was forced out by a plasma generated at the following timing and burst out.

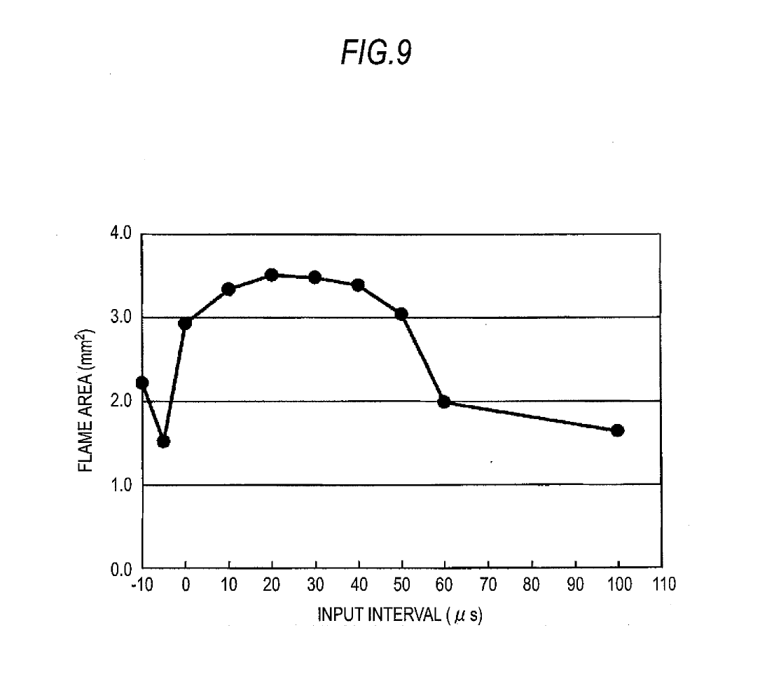

The flame area was measured by inputting electric power two times in a single spark discharge while changing an interval (input interval) from the end timing of the first input of electric power to the start timing of the second input of electric power in various manners. In this test, the sample A was installed in a predetermined chamber and an internal pressure of the chamber was set to 0.4 MPa, an internal atmosphere of the chamber was made a standard gas atmosphere, and supply energy per input of electric power was set to 30 mJ. Then, a schlieren image after 200 is from a spark discharge was obtained. The schlieren image thus obtained was converted to a digital form using the same threshold as the one used in the test above to measure the flame area. FIG. 9 is a graph showing a relation of the input interval and the flame area. The term, “the end timing of an input of electric power”, referred to herein means a time when a current value of electric power inputted drops to or below 5% of a peak value when the electric power is inputted. In FIG. 9, an input interval of a minus value means a case where electric power is inputted second time so as to overlap at least partially on the first input of electric power.

As is shown in FIG. 9, it was found that when the input interval had a minus value, the flame area became relatively small and ignitability was not enhanced sufficiently. The reason for this is believed to be that sufficient fresh air necessary to generate a following plasma was absent in the cavity because the cavity was filled with a plasma generated by the first input of electric power.

Also, it was confirmed that ignitability was not enhanced sufficiently, either, when the input interval was made longer than 50 μs. The reason for this is believed to be that efficiency of forcing out a preceding plasma by a following plasma was not exerted sufficiently because most of a plasma generated by the first input of electric power disappeared before a plasma was generated by the second input of electric power (namely, merely a plasma was generated separately by each input).

In contrast, it became obvious that when the start timing of the second input of electric power was set after the end timing of the first input of electric power and within 50 μs from the end timing of this input (in a case where the input interval was set to a range from 0 μm to 50 μm), the flame area increased markedly and ignitability became excellent. The reason for this is believed to be that sufficient fresh air necessary to generate a following plasma was present in the cavity at the second input of electric power by setting the input interval to longer than 0 μs so that it became possible to generate a sufficiently large plasma by the second input of electric power. Moreover, a large plasma generated by the second input of electric power was able to force a plasma generated by the first input of electric power out of the cavity before it disappeared by setting the input interval to within 50 μs. Also, it was confirmed that the flame area exceeded 3.0 mm² when the input interval was set to a range from 10 μs to 50 μs both inclusive, and particularly, the flame area increased further and extremely excellent ignitability was achieved when the input interval was set to a range from 10 μs to 40 μs both inclusive.

From the test results above, in order to enhance ignitability with a plasma jet spark plug having a cavity, it can be said that it is preferable to input electric power more than once in a single spark discharge and to set the start timing of the second and subsequent inputs of electric power in a single spark discharge after the end timing of the immediately preceding input of electric power and within 50 μs from the end timing of this input.

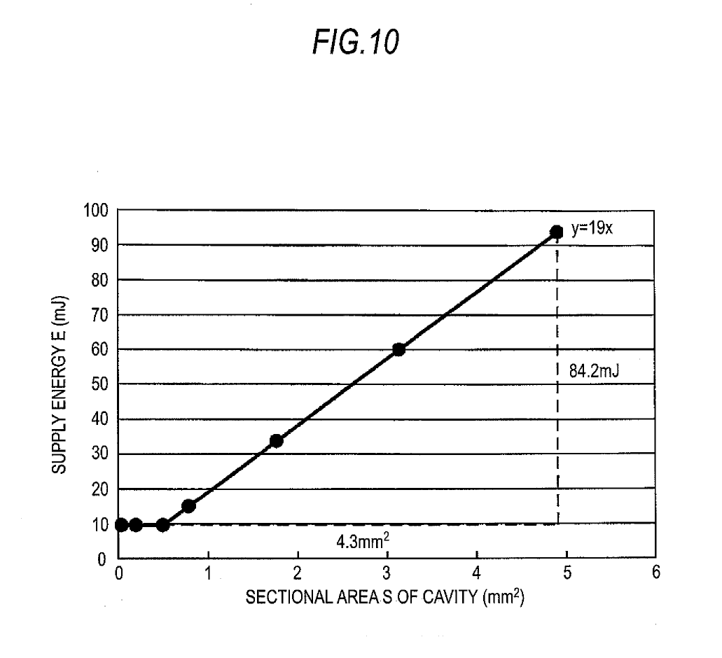

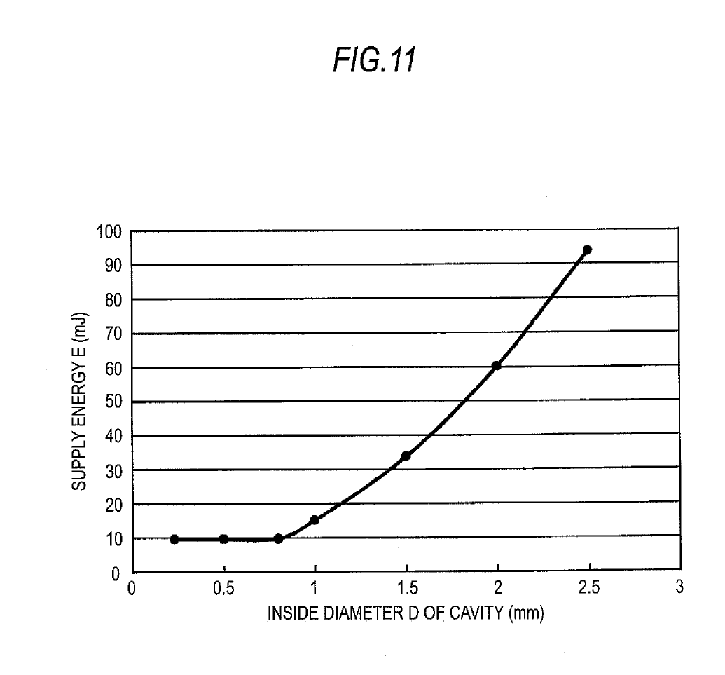

Then, samples of a plasma jet spark plug were manufactured. In these samples, a sectional area S (mm²) of the cavity was changed in various manners along a direction orthogonal to the axis line by changing the inside diameter D (mm) of the cavity. Each sample was installed in a predetermined chamber. Then, an internal pressure of the chamber was set to 0.4 MPa and an internal atmosphere of the chamber was made a standard gas atmosphere. Supply energy E at an input of electric power necessary for a plasma to be ejected by 0.4 mm or more from a through hole in the ground electrode was measured in each sample. An ejection amount of a plasma was calculated according to an image of the plasma captured by a camera with a sufficiently long exposure time (about 1 s) (a plasma with a maximum ejection amount appears in this image). FIG. 10 is a graph showing a relation of the sectional area S of the cavity and the supply energy E. FIG. 11 is a graph showing a relation of the inside diameter D of the cavity and the supply energy E. The reason why the supply energy E was measured using 0.4 mm as the reference in this test is because when an ejection amount of a plasma is set to 0.4 mm or more, it becomes possible to fill the cavity with a plasma sufficiently and thereby to let efficiency of forcing out a preceding plasma by a following plasma be exerted in a more reliable manner (it is, however, possible to obtain sufficient plasma forcing out efficiency even when an ejection amount of a plasma is less than 0.4 mm). In all the samples, a length of the cavity along the direction of the axis line was set to a range from 0.5 mm to 2.5 mm.

As are shown in FIG. 10 and FIG. 11, it was found that a plasma was ejected sufficiently (namely, the cavity was filled with plasma) by setting the supply energy E to about 9.6 mJ [=19 (mJ/mm²)×π×(0.4 mm)²] with a sample in which the inside diameter D of the cavity was set to 0.8 mm or less (the sectional area S was set to about 0.503 mm² or less) and by setting the supply energy E to 19 (mJ/mm²)×π×(D/2)² with a sample in which the inside diameter D of the cavity was set to greater than 0.8 mm.

From the test result as above, in terms of filling the cavity with a plasma and enhancing ignitability further, it can be said that it is preferable to adjust energy to be supplied per input of electric power according to the inside diameter D of the cavity to satisfy:

when D≦0.8,

E≧19 (mJ/mm²)×π×(0.4 mm)², and

when D>0.8,

E≧19 (mJ/mm²)×π×(D/2)².

Then, a spark plug was installed in a chamber set under the same conditions as those of the tests above (at an internal pressure of 0.4 MPa in a standard gas atmosphere) and a setting was made to input electric power one time in a single spark discharge. Then, a time from a spark discharge until the input of electric power is started (input delay time) was changed in various manners and electric power was inputted 100 times in each input delay time. The number of times when a plasma was generated normally (the number of normal generation times) was counted by observing a current waveform at the input of electric power and a ratio (normal generation ratio) of the number of normal generation times to 100 times was calculated. The normal generation ratios for the respective input delay times are set forth in Table 1 below. The supply energy at the input of electric power was 60 mJ and the spark plug used was of the same shape as the sample A.

TABLE 1

| | Input delay time (μs) | | | | | | | | | | |
|---|---|---|---|---|---|---|---|---|---|---|---|
| | 0 | 50 | 100 | 150 | 200 | 300 | 400 | 500 | 600 | 700 | 1000 |
| Normal gener- | 100 | 100 | 100 | 100 | 100 | 100 | 100 | 100 | 78 | 12 | 0 |
| ation ratio (%) | | | | | | | | | | | |

As is set forth in Table 1 above, it was found that there was a possibility of trouble in stable generation of a plasma when the input delay time was set longer than 500 μs. The reason for this is believed to be that a spark discharge had already ended before the input of electric power or the resistance of the clearance increased from the one immediately after a spark discharge due to an input delay time set excessively long.

In contrast, it was confirmed that the normal generation ratio was 100% when the input delay time was set within 500 μs and it was possible to generate a plasma in an extremely stable manner. The reason for this is believed to be that a spark discharge existed until the input of electric power and the resistance of the clearance was sufficiently small.

From the test result above, in terms of generating a plasma in a stable manner, it can be said that it is preferable to set the start timing of the last input of electric power in a single spark discharge within 500 μs from the start of the spark discharge.

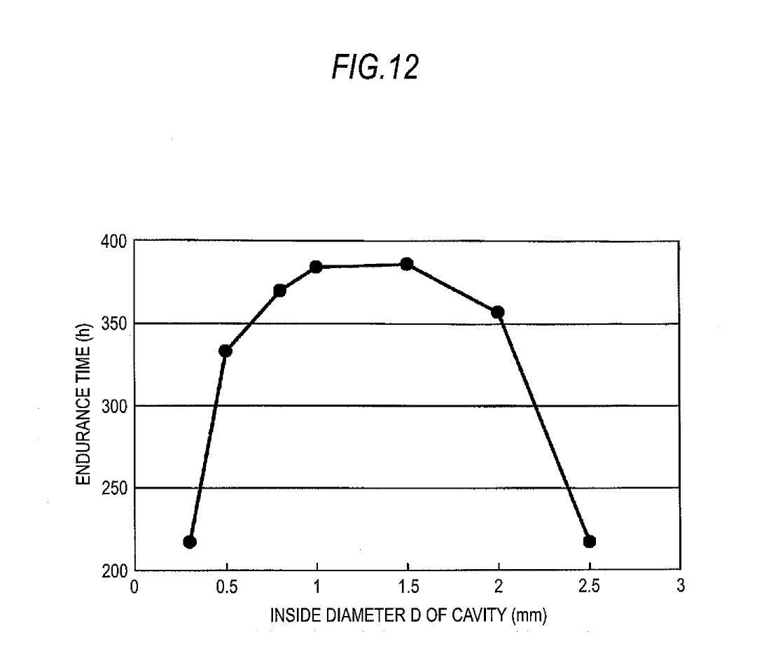

Then, samples of a spark plug were manufactured by changing the inside diameter D (mm) of the cavity in various manners. Each sample was installed in a chamber set under the same conditions as those in the tests above and a spark discharge was caused in each sample by setting a frequency of an applied voltage to 60 Hz. Then, a plasma was generated by inputting electric power two times in a single spark discharge. A time (endurance time) until a wear volume of the center electrode reached 1 mm³ was measured in each sample. FIG. 12 is a graph showing a relation of the inside diameter D of the cavity and the endurance time. The energy E of electric power per input was set to satisfy: E=19 (mJ/mm²)×π×(D/2)² (in other words, set to energy with which an ejection amount of a plasma of at least 0.4 mm can be achieved and the cavity can be filled with a plasma). In all the samples, the top end of the center electrode was made of W alloy.

As is shown in FIG. 12, it became obvious that a sample in which the inside diameter D of the cavity was made smaller than 0.5 mm had poor wear resistance. The reason for this is believed to be that the top end of the center electrode became narrower as the inside diameter of the cavity was made smaller and heat conduction of the center electrode was therefore deteriorated.

It was also found that a sample in which the inside diameter D of the cavity was larger than 2.0 mm had insufficient wear resistance. The reason for this is believed to be that energy necessary to fill the cavity with a plasma became extremely large by making the inside diameter D of the cavity larger than 2.0 mm and the center electrode was therefore vulnerable to wear at the input of electric power.

In contrast, it was confirmed that samples in which the inside diameter D of the cavity was set to a range from 0.5 mm to 2.0 mm both inclusive had excellent wear resistance with an endurance time exceeding 300 hours.

From the test result above, it can be said that it is preferable to set the inside diameter D of the cavity to a range from 0.5 mm to 2.0 mm both inclusive in order to enhance the wear resistance of the center electrode.

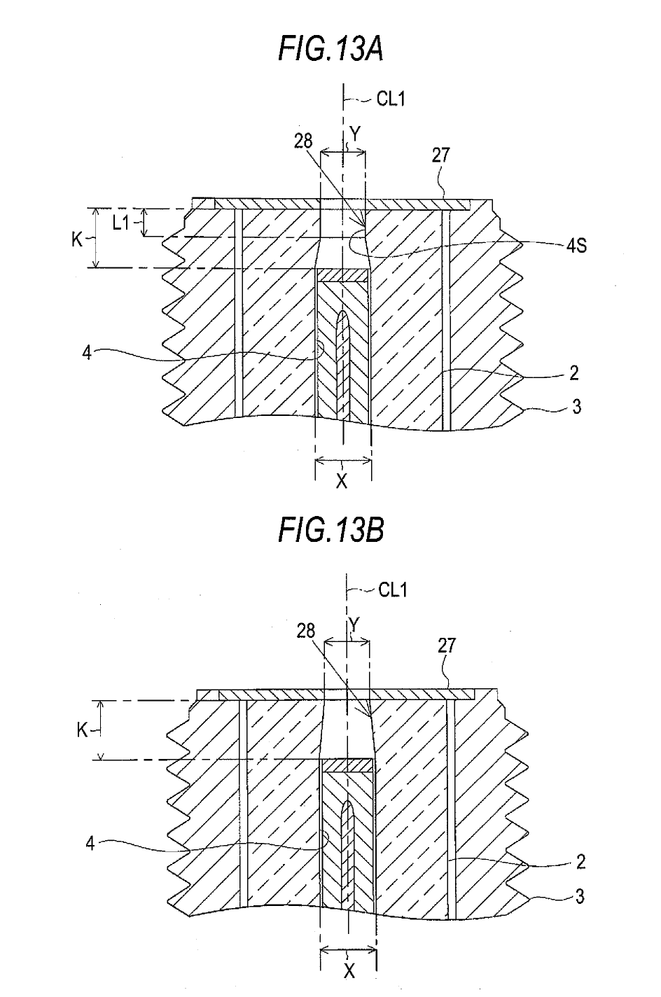

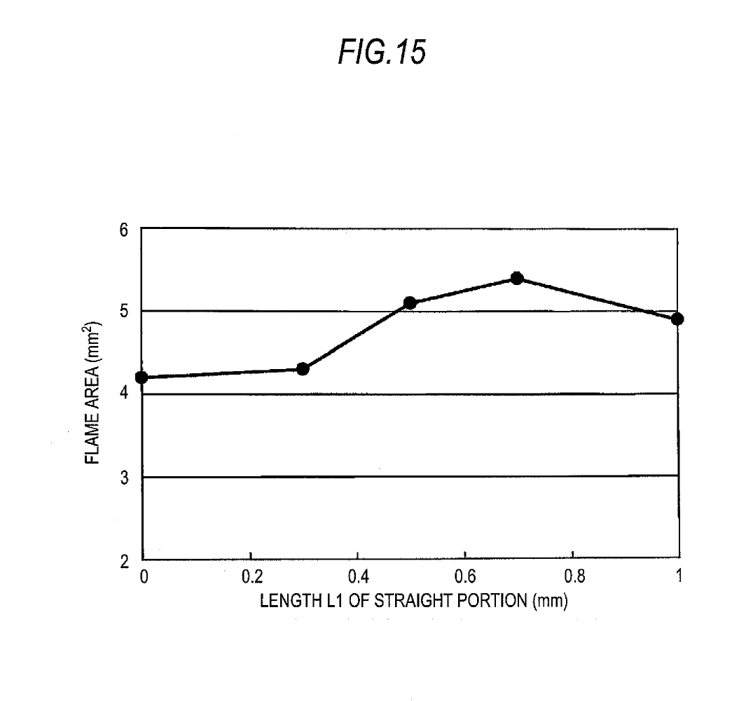

Then, as is shown in FIG. 13A, samples (samples C) of a spark plug were manufactured. In these samples, a diameter shrinking portion having an inside diameter shrinking toward the top end in the direction of the axis line was provided to the cavity in a region on the side of the center electrode while a straight portion having a constant inside diameter was provided from the top end of the axis hole (cavity) toward the rear end in the direction of the axis line and a length L1 (mm) of the straight portion along the axis line was changed in various manners. Also, as is shown in FIG. 13B, a sample (sample D) of a spark plug was manufactured. In this sample, the diameter of the cavity kept reducing toward the top end all along the direction of the axis line (namely, no straight portion was provided). Then, the flame area was measured in each sample. FIG. 15 is a graph showing a relation of the length L1 of the straight portion and the flame area (in FIG. 15, the test result when the length L1 of the straight portion was 0 mm is the test result of the sample D provided with no straight portion). In this test, electric power was inputted two times in a single spark discharge at an input interval of 20 μs and energy of electric power per input was set to 30 mJ. Moreover, the flame area was measured according to a schlieren image after 100 μs from a spark discharge. Of the cavity, an inside diameter X in a region corresponding to the top end surface of the center electrode in the direction of the axis line was set to 1.0 mm and an inside diameter Y in a boundary between the straight portion and the diameter shrinking portion (the top end of the cavity in the sample D provided with no straight portion) was set to 0.8 mm in all the samples. In addition, a length K of the cavity along the axis line was set to 1.0 mm.

As is shown in FIG. 15, it became obvious that the flame area increased and further enhanced ignitability was achieved with samples provided with the straight portion as long as or longer than 0.5 mm in comparison with the sample D provided with no straight portion and samples provided with the straight portion having the length L shorter than 0.5 mm. The reason for this is believed to be that fresh air flew more smoothly into the cavity owing to the sufficiently long straight portion provided on the top end side of the cavity and it became possible to generate a further larger plasma at the second input of electric power.

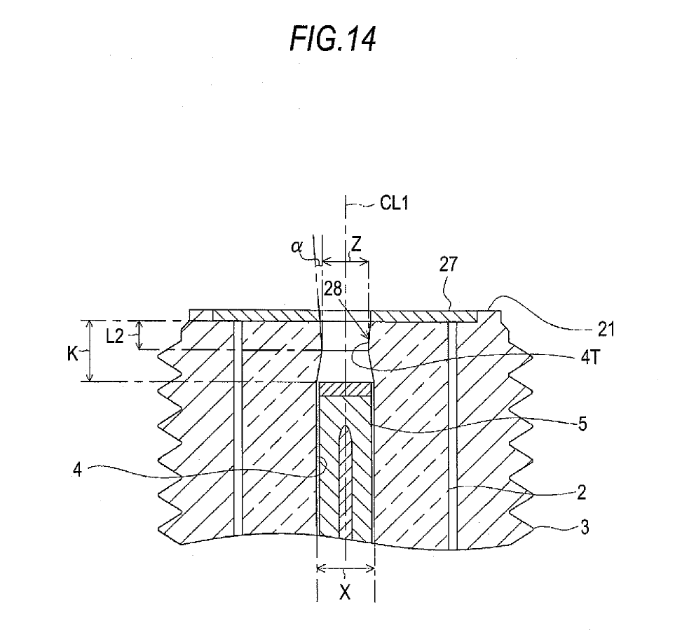

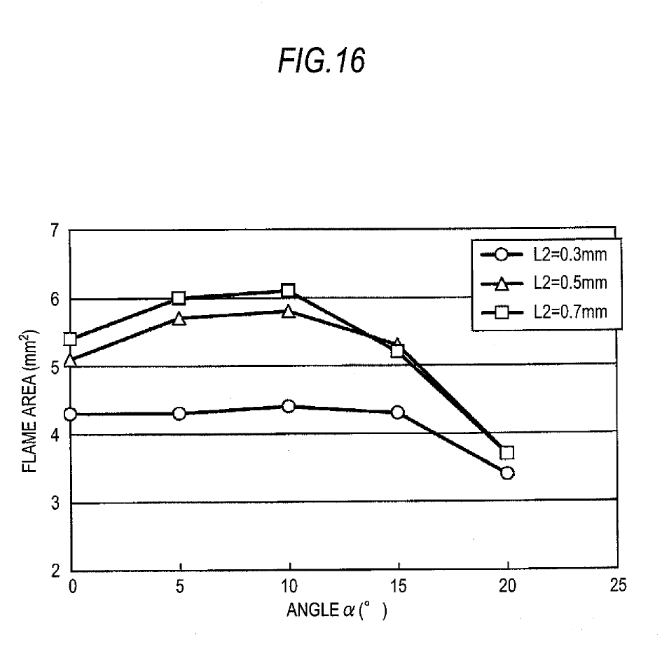

Then, as is shown in FIG. 14, samples (samples E) of a spark plug were manufactured. In these samples, a diameter shrinking portion having an inside diameter shrinking toward the top end in the direction of the axis line was provided to the cavity in a region on the side of the center electrode while a diameter expanding portion having an inside diameter expanding toward the top end in the direction of the axis line was provided to the axis hole (cavity) on the top end side and a length L2 (mm) of the diameter expanding portion along the axis line was set to 0.3 mm, 0.5 mm, or 0.7 mm and an acute angle α (°) complementary to an obtuse angle yielded between a visible outline of the diameter expanding portion and the axis line in a cross section including the axis line was changed in various manners. The flame area was measured in each sample. FIG. 16 shows the result of this test. In FIG. 16, circles indicate the test result of a sample in which the length L2 of the diameter expanding portion was set to 0.3 mm, triangles indicate the test result of a sample in which the length L2 of the diameter expanding portion was set to 0.5 mm, and squares indicate the test result of a sample in which the length L2 of the diameter expanding portion was set to 0.7 mm. Also, in this test, electric power was inputted two times in a single spark discharge at an input interval of 20 μs and energy of electric power per input was set to 30 mJ. Moreover, the flame area was measured according to a schlieren image after 100 μs from a spark discharge. In addition, the inside diameter X was set to 1.0 mm, the length K of the cavity to 1.0 mm, and an inside diameter Z at a boundary between the diameter shrinking portion and the diameter expanding portion to 0.8 mm.

As is shown in FIG. 16, it was confirmed that the flame area increased and ignitability was excellent in the samples in which the length L2 of the diameter expanding portion was set to 0.5 mm or longer. The reason for this is believed to be that fresh air flew more smoothly into the cavity owing to the sufficiently long diameter expanding portion. Also, it was found that the flame area increased further and ignitability was extremely excellent particularly in the samples in which the angle α was set to 15° or less. The reason for this is believed to be that scattering of an ejected plasma was suppressed by making the angle α relatively small.

From the test result above, it can be said that it is preferable to provide at least one of a straight portion having a constant inside diameter and a diameter expanding portion having an inside diameter expanding toward the top end in the direction of the axis line to the axis hole in a range of at least 0.5 mm from the top end of the axis hole (cavity) toward the rear end in the direction of the axis line in order to further enhance ignitability. Also, in order to enhance ignitability still further, it can be said that it is preferable to provide a diameter expanding portion having a length of 0.5 mm or longer and set the angle α of the diameter expanding portion to satisfy: 0°<α≦15°.

The invention is not limited to the descriptions of the embodiment above and may be implemented, for example, as follows. It goes without saying that the invention also include modifications and alterations other than those described below.

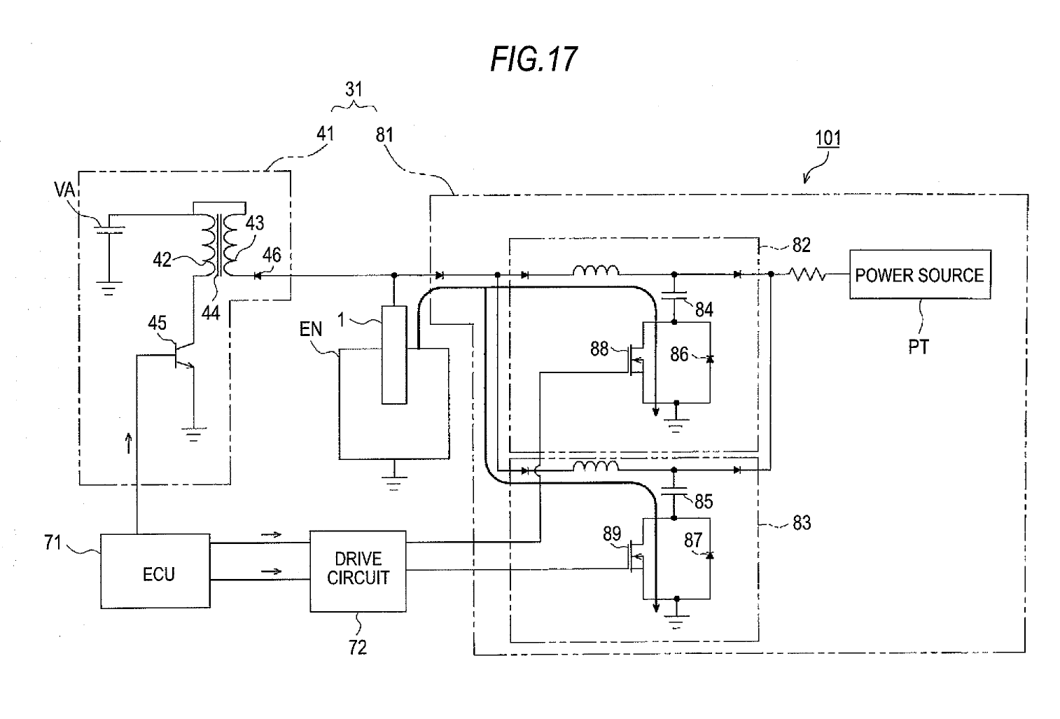

(a) The configuration of the energy input portion 51 of the embodiment above is a mere example and the energy input portion can be any device capable of inputting electric power into the clearance 29 more than once in a single spark discharge. Hence, for example, as is shown in FIG. 17, it is possible to use an energy input portion 81 provided with a first energy input portion 82 and a second energy input portion 83 connected in parallel and a power source PT generating a voltage of a negative polarity. Herein, the energy input portion 82 (83) includes a capacitor 84 (85), a backflow preventing diode 86 (87) connected to the capacitor 84 (85) in series, and a switch 88 (89) connected to the diode 86 (87) in parallel. The capacitor 84 (85) is connected between the power source PT and the spark plug 1 at one end and the diode 86 (87) is grounded at one end on the side opposite to the end connected to the capacitor 84 (85). In addition, the switch 88 (89) is controlled by the ECU 71. The capacitor 84 (85) is charged by the power source PT when the switch 88 (89) is switched OFF by the ECU 71 whereas electric power stored in the capacitor 84 (85) is inputted into the spark plug 1 when the switch 88 (89) is switched ON by the ECU 71. According to the energy input portion 81 configured as above, as with the energy input portion 51 of the embodiment above, it becomes possible to input electric power more than once in a single spark discharge by controlling ON and OFF actions of the switch 88 (89).

(b) In the embodiment above, the respective switches 56 through 59, 88, and 89 are formed of MOSFETs. However, the respective switches may be formed of other semiconductor switches (for example, transistors) or mechanical switches.

(c) In the embodiment above, the energy input portions 52, 53, 82, and 83 are controlled by the ECU 71. However, a microcomputer may be provided separately to control the energy input portions 52, 53, 82, and 83 by this microcomputer.

(d) In the embodiment above, the discharge power source 41 and the energy input portion 51 are provided to each spark plug 1. However, the discharge power source 41 and the like are not necessarily provided to each spark plug 1. Electric power from the discharge power source or the energy input portion may be supplied to each spark plug 1 via a distributor.

(e) In the embodiment above, the ground electrode 27 is made of metal, such as W and Ir. However, the ground electrode 27 may be formed of metal, such as W and Ir, only in a region on the inner peripheral side that wears with a spark discharge.

(f) In the embodiment above, the electrode chip 5C is provided to the top end of the center electrode 5. However, the center electrode 5 may be formed without providing the electrode chip 5C.

Having described the invention, the following is claimed:

1. An ignition system, comprising:
a plasma jet spark plug that includes an insulator having an axis hole extending in a direction of an axis line, a center electrode inserted into the axis hole and installed therein in such a manner that a top end surface is situated closer to a rear end than a top end of the insulator in the direction of the axis line, a ground electrode disposed so as to be situated closer to the top end than the top end of the insulator in the direction of the axis line and forming a clearance with the center electrode in between, and a cavity defined by an inner peripheral surface of the axis hole and the top end surface of the center electrode;
a discharge power source that applies a voltage to the clearance; and
an energy input portion that inputs electric power into the clearance,
the ignition system being capable of generating a plasma in the cavity by generating a spark discharge in the clearance by applying a voltage to the clearance from the discharge power source and by inputting electric power into the clearance,
wherein:
the energy input portion is formed to be capable of inputting electric power into the clearance more than once in a single spark discharge; and
start timing of second and subsequent inputs of the electric power in the single spark discharge is set after end timing of an immediately preceding input of the electric power and within 50 μs from the end timing of the immediately preceding input.

2. The ignition system according to claim 1, wherein:
let D (mm) be an inside diameter of the cavity and E (mJ) be energy to be supplied to the clearance from the energy input portion per input of the electric power, then inequalities below are satisfied:
when D≦0.8,
E≧19 (mJ/mm²)×π×(0.4 mm)², and
when D>0.8,
E≧19 (mJ/mm²)×π×(D/2)².

3. The ignition system according to claim 1, wherein:
the start timing of a last input of the electric power in the single spark discharge is set within 500 μs from a start of the spark discharge.

4. The ignition system according to claim 1, wherein:
let D (mm) be an inside diameter of the cavity, then an inequality below is satisfied:
0.5≦D≦2.0.

5. The ignition system according to claim 1, wherein:
at least one of a straight portion having a constant inside diameter and a diameter expanding portion having an inside diameter expanding toward the top end in the direction of the axis line is provided to the axis hole in a range of at least 0.5 mm from the top end of the axis hole toward the rear end in the direction of the axis line.

6. The ignition system according to claim 5, wherein:
the diameter expanding portion is provided to the axis hole in the region of at least 0.5 mm from the top end of the axis hole toward the rear end in the direction of the axis line; and
let α (°) be an acute angle complementary to an obtuse angle yielded between a visible outline of the diameter expanding portion and the axis line in a cross section including the axis line, then an inequality below is satisfied:
0<α≦15.

7. The ignition system according to claim 1, wherein:
of the center electrode, a region of 0.3 mm from a top end thereof toward the rear end in the direction of the axis line is made of one of metals including tungsten, iridium, platinum, and nickel and alloy having at least one of the metals as a chief ingredient.

8. The ignition system according to claim 1, wherein:
the ground electrode is made of one of metals including tungsten, iridium, platinum, and nickel and alloy having at least one of the metals as a chief ingredient.

9. An ignition method of an ignition system having: a plasma jet spark plug that includes an insulator having an axis hole extending in a direction of an axis line, a center electrode inserted into the axis hole and installed therein in such a manner that a top end surface is situated closer to a rear end than a top end of the insulator in the direction of the axis line, a ground electrode disposed so as to be situated closer to the top end than the top end of the insulator in the direction of the axis line and forming a clearance with the center electrode in between, and a cavity defined by an inner peripheral surface of the axis hole and the top end surface of the center electrode; a discharge power source that applies a voltage to the clearance; and an energy input portion that inputs electric power into the clearance, for generating a plasma in the cavity by generating a spark discharge in the clearance by applying a voltage to the clearance from the discharge power source and by inputting electric power into the clearance,
the method comprising:
inputting electric power into the clearance more than once in a single spark discharge from the energy input portion; and
setting start timing of second and subsequent inputs of the electric power in the single spark discharge after end timing of an immediately preceding input of the electric power and within 50 μs from the end timing of the immediately preceding input.
